(19) United States
(12) Patent Application Publication
(10) Pub. No.: US 2012/0002047 A1
(43) Pub. Date: Jan. 5, 2012

(54) MONITORING CAMERA AND METHOD OF TRACING SOUND SOURCE

(76) Inventors: Kwang Ho An, Seoul (KR); Sung Jin Kim, Seoul (KR)

(21) Appl. No.: 13/114,662

(22) Filed: May 24, 2011

(30) Foreign Application Priority Data
Jul. 1, 2010 (KR) 10-2010-0063499

(51) Int. Cl. H04N 7/18

(52) U.S. Cl. 348/143; 348/E07.085

(57) ABSTRACT

This document relates to a monitoring camera and a method of tracing a sound source. In an embodiment of this document, patterns of sounds received through a plurality of microphones are detected. The detected patterns of the sounds are compared with a reference sound pattern. A sound source position is traced and photographed by controlling one or more of pan/tilt operations and a zoom operation according to a result of the comparison. Accordingly, an emergency situation can be photographed more efficiently. An announcer can be automatically selected from a plurality of attendants and photographed by applying the monitoring camera to a Video Conference System (VCS).

This application claims the benefit of Korean Patent Application No. 10-2010-0063499 filed on Jul. 1, 2010, which is hereby incorporated by reference.

### BACKGROUND

1. Field

This document relates to a monitoring camera and a method of tracing a sound source.

2. Related Art

In general, a fixed camera or a mobile camera is used in a monitoring system for monitoring a subject. A PTZ camera equipped with, for example, pan, tilt, and zoom functions is widely used as the mobile camera. In particular, a dome camera for preventing damage due to external shocks is being widely used by installing the PTZ camera within the dome casing.

The pan function is a function of moving the photographing direction of a camera in a horizontal direction. The tilt function is a function of moving the photographing direction of a camera in a vertical direction. The zoom function is a function of enlarging or reducing the size of a subject photographed by a camera.

Furthermore, a monitoring system in which the mobile camera, for example, a dome camera is used, a camera image is received, displayed on a monitor screen, and stored in a recording medium, such as a hard disk. A user who operates the monitoring system checks a situation of a monitoring area while seeing the camera image displayed on the monitor screen.

For example, as shown in FIG. 1, images of respective channels captured by a plurality of dome cameras 100₁ to 100ₙ are transmitted to the central server 300 of a monitoring system which is connected to the dome cameras over a network 200. The images may be displayed on the screen of a display board 400 connected to the central server 300 for each channel.

A user who operates the monitoring system can check situations of the areas where the dome cameras 100₁ to 100ₙ are installed through the camera images captured in real time and can control the pan, tilt, and zoom operations of the dome cameras remotely through the central server 300 so that a desired photographing angle and a desired zoom state are achieved.

In the case where places where the dome cameras are installed are blind spots, such as areas outside military units, areas neighboring the playgrounds of schools, alleys rarely inhabited, or the underground parking lots of apartments, there is an urgent and efficient solution for more actively monitoring emergency situations occurring in the blind spots.

### SUMMARY

An aspect of this document is to provide a method of more efficiently tracing emergency situations occurring in blind spots in camera photographing.

A monitoring camera according to an aspect of this document comprises a camera unit for photographing a subject; a pan/tilt unit for rotating the camera unit; a control unit for controlling the camera unit and the pan/tilt unit; and a plurality of microphones for detecting sounds. The control unit controls one or more of the pan/tilt unit and the camera unit by comparing a reference sound pattern and the sounds detected by the microphones.

A method of a monitoring camera tracing a sound source according to another aspect of this document comprises detecting patterns of sounds received through a plurality of microphones; comparing the detected patterns of the sounds and a reference sound pattern; and tracing and photographing a sound source position by controlling one or more of pan/tilt operations and a zoom operation according to a result of the comparison.

In an embodiment, the three or more microphones may be arranged at specific intervals in a dome casing for protecting the camera unit, the pan/tilt unit, and the control unit.

In an embodiment, the reference sound pattern may be obtained through a learning process and stored after the monitoring camera is installed or is previously stored before the monitoring camera is installed.

In an embodiment, when the detected sounds are not similar to the reference sound pattern, the control unit may detect a sound source position and trace and photograph the sound source position by controlling one or more of pan/tilt operations of the pan/tilt unit and a zoom operation of the camera unit.

In an embodiment, the control unit may detect the sound source position based on a difference between the times taken for the sounds to reach the respective microphones.

In an embodiment, the control unit may control the zoom operation in a wide-angle state during the pan/tilt operations and, after the pan/tilt operations are completed, controls the zoom operation in a telescopic state corresponding to the sound source position.

In an embodiment, when controlling one or more of the pan/tilt unit and the camera unit, the control unit may send an event message, informing an emergence situation, to a server connected to the control unit over a network.

In an embodiment, when controlling one or more of the pan/tilt unit and the camera unit, the control unit may perform a recording operation for recording the sounds detected by the microphones.

In an embodiment, the control unit may perform the recording operation by selecting the sound of the microphone close to a photographing direction of the monitoring camera, from the sounds detected by the microphones, or assigning a high weight to the sound close to the photographing direction.

Accordingly, an emergency situation can be more efficiently photographed by tracing a sound source occurring in a blind spot in camera photographing. Furthermore, if the dome camera is applied to a VCS, an announcer can be automatically selected from a plurality of attendants and photographed.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 is a diagram showing an embodiment in which a plurality of dome cameras is connected to a central server over a network;

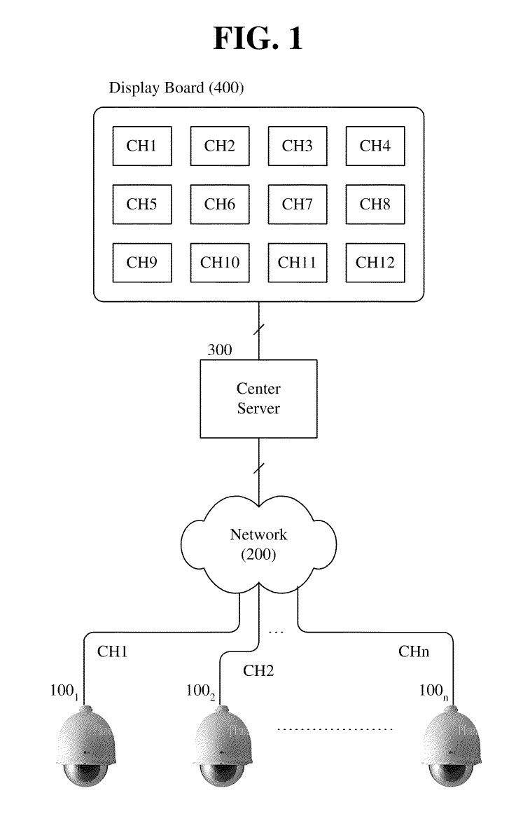

FIG. 2 is a diagram showing an embodiment in which a plurality of microphones is installed in a dome camera which is one of monitoring cameras to which this document is applied;

FIG. 3 is a diagram showing the construction of a dome camera which is one of monitoring cameras to which this document is applied;

FIG. 4 is a diagram showing a plurality of reference sound patterns which are managed according to an embodiment of this document;

FIG. 5 is a flowchart illustrating a method of tracing a sound source in the monitoring camera according to an embodiment of this document;

FIG. 6 is a diagram showing an embodiment in which an event is generated according to surrounding sound patterns detected according to this document; and

FIG. 7 is a diagram showing an embodiment in which the position of a sound source is detected according to this document.

### DETAILED DESCRIPTION

A monitoring camera and a method of tracing a sound source according to some exemplary embodiments of this document are described below.

This document is applied to various monitoring cameras, such as dome cameras, and a plurality of microphones for detecting a sound is installed in the dome camera.

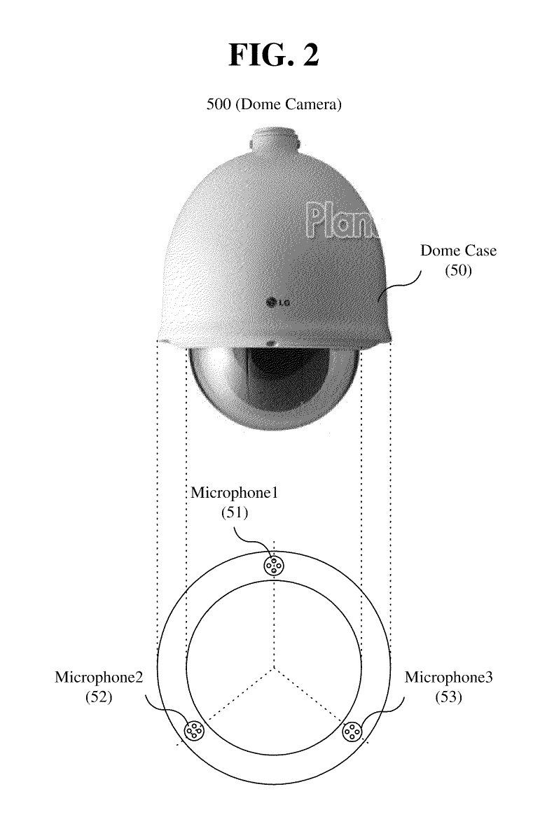

As shown in FIG. 2, for example, three microphones 51, 52, and 53 may be disposed in specific portions of a dome casing 50, constituting a dome camera 500, at regular intervals of 120° and configured to detect surround sounds.

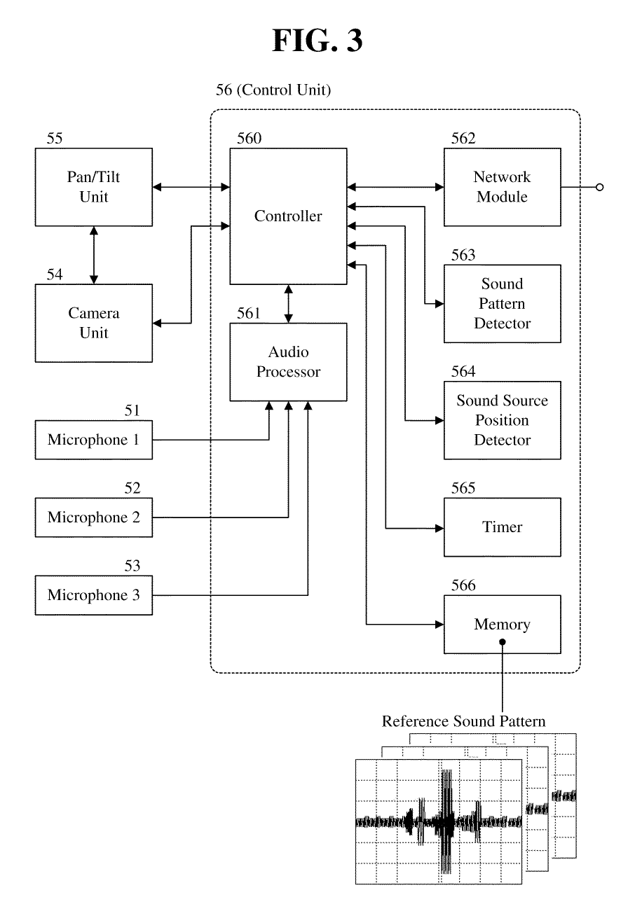

As shown in FIG. 3, the dome camera 500 may comprise, for example, a camera unit 54 for photographing a subject, a pan/tilt unit 55 for rotating the camera unit in a horizontal direction and a vertical direction, and a control unit 56 for controlling the zoom operation of the camera unit 54 and the pan/tilt operations of the pan/tilt unit 55.

The control unit 56 may comprise, for example, a controller 560, an audio processor 561, a network module 562, an sound pattern detector 563, a sound source position detector 564, a timer 565, and memory 566. The sound pattern detector 563 and the sound source position detector 564 may be constructed in software within the controller 560. The memory 566 may be various types of nonvolatile memories, such as flash memory, and a plurality of reference sound patterns may be stored and managed in the memory 566.

The reference sound patterns may be obtained through a learning process, stored, and updated after the dome camera is installed at a specific place, or may be previously stored as experimental result values before the dome camera is installed at a specific place.

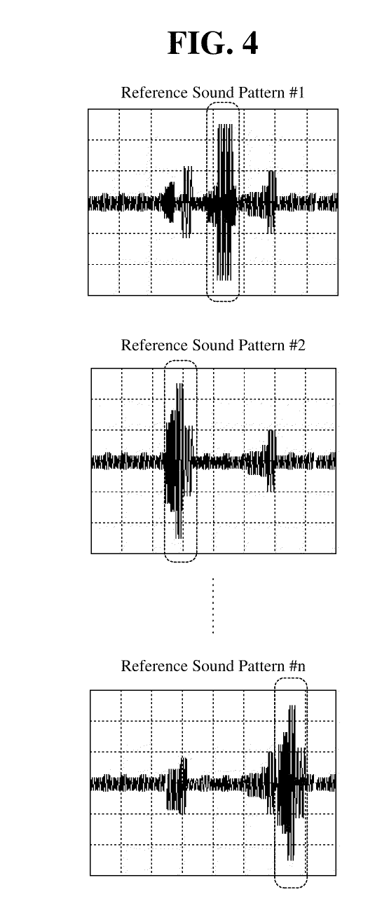

Furthermore, as shown in FIG. 4, the reference sound patterns may be, for example, various sound patterns which are typically generated at a specific place where the dome camera is installed, and they may have a unique frequency, amplitude, or waveform characteristic.

In some embodiments, specific sound patterns that may be generated in emergency situations, such as people screaming or gun shots which are not typically generated at a specific place where the dome camera is installed, may be stored as the reference sound patterns.

Meanwhile, the audio processor 561 amplifies and processes surrounding sounds, respectively received through the first to third microphones 51 to 53, as audio signals of a specific level or higher. The sound pattern detector 563 detects surrounding sound patterns by analyzing the frequency, amplitude, and waveform characteristics of the audio signals.

The controller 560 compares the detected surrounding sound patterns and the reference sound patterns stored in the memory 566. If, as a result of the comparison, the surrounding sound patterns are abnormal patterns not similar to the reference sound patterns, the controller 560 determines that an emergency situation has occurred.

For reference, in the case where specific sound patterns (e.g., people screaming and gun shots) which are not typically generated at a specific place where the dome camera is installed are stored as the reference sound patterns, when the surrounding sound patterns are similar to the reference sound patterns, the controller 560 determines that an emergency situation has occurred.

If the emergency situation is determined to have occurred as described above, the controller 560 automatically generates a relevant event message and sends the event message to the central server 300 of the monitoring system connected thereto through the network module 562.

When the event message is received, the central server 300 displays a warming message on the monitor screen of a relevant channel allocated to the dome camera 500 or outputs an alarm so that a user who operates the monitoring system can rapidly know the emergency situation.

The controller 560 sends the event message and, at the same time, controls the sound source position detector 564 so that the sound source position detector 564 detects a sound source position where the sound of the abnormal patterns is generated and tracing and photographing the sound source position by controlling one or more of the pan/tilt operations of the pan/tilt unit 55 and the zoom operation of the camera unit 54 based on the detected sound source position. Furthermore, the controller 560 automatically performs an audio recording operation. This is described in detail below.

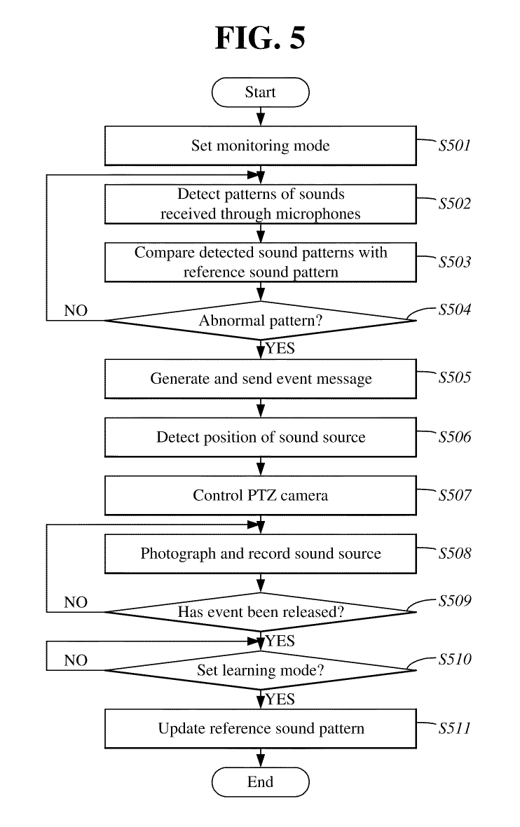

FIG. 5 is a flowchart illustrating a method of tracing a sound source in the monitoring camera according to an embodiment of this document.

When a monitoring mode is set in the dome camera 500 to which this document is applied at step S501, the camera unit 54 performs an operation of photographing a subject. The control unit 56, as described above with reference to FIG. 2, detects surrounding sound patterns by analyzing the frequency, amplitude, and waveform characteristics of each of surrounding sounds received through the first to third microphones 51 to 53 which are disposed at regular intervals (e.g., 120° in the outer circumference of the dome casing 50 at step S502. For example, the sound pattern detector 563 of the control unit 56 analyzes the frequency, amplitude, and waveform characteristics of each of the surrounding sounds which are amplified to a specific decibel (e.g., 50 dB or higher) and received.

Furthermore, the sound pattern detector 563 detects a first surrounding sound pattern received through the first microphone 51, a second surrounding sound pattern received through the second microphone 52, and a third surrounding sound pattern received through the third microphone 53.

The controller 560 of the control unit 56 determines whether an abnormal pattern has been detected (S504) by comparing only some of or all the first surrounding sound pattern, the second surrounding sound pattern, and the third surrounding sound pattern with a plurality of reference sound patterns stored in the memory 566 at step S503.

For reference, the sound pattern detector 563 may determine whether a sound of an abnormal pattern has been generated by selecting only a surrounding sound having the highest signal level (e.g., a first surrounding sound received through the first microphone 51), from among first to third surrounding sounds respectively received through the first to third microphones 51 to 53, detecting the first surrounding sound pattern by analyzing the frequency, amplitude, and waveform characteristic of the first surrounding sound, and comparing the detected first surrounding sound pattern with the plurality of reference sound patterns stored in the memory 566.

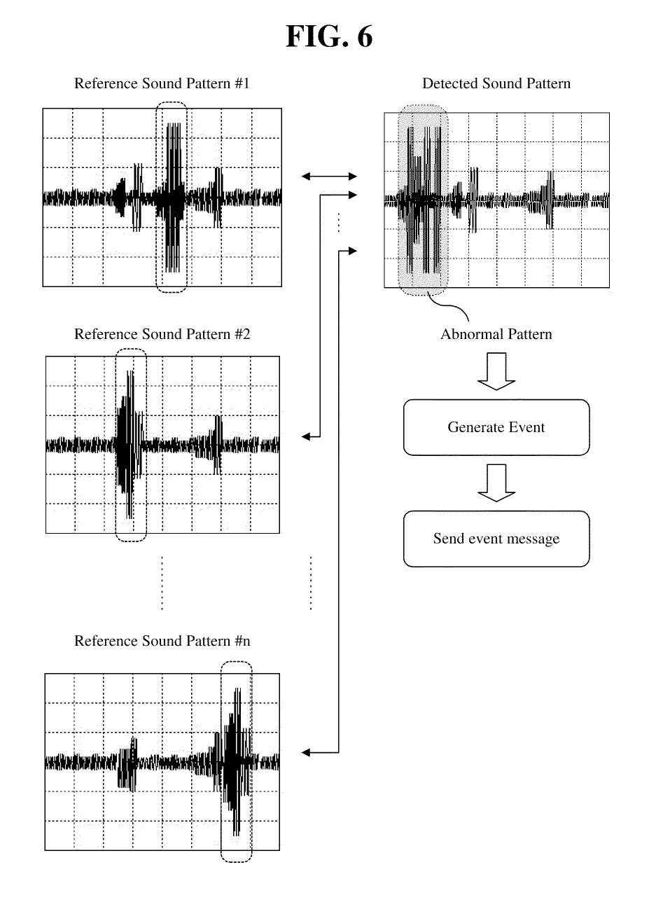

For example, as shown in FIG. 6, if, as a result of the determination at step S504, the sound of the abnormal pattern is determined to have been detected, the controller 560 generates an event informing an emergency situation and, at the same time, generates a relevant event message and sends the event message to the central server 300 of the monitoring system, connected thereto through the network module 562, at step S505.

In response to the event message, the central server 300 displays a warning message on the monitor screen of a channel allocated to the dome camera 500 or generates an alarm so that a user who operates the monitoring system can rapidly know the emergency situation.

When the event is generated as described above, the controller 560 controls the sound source position detector 564 so that the sound source position detector 564 detects a sound source position of the abnormal pattern at step S506.

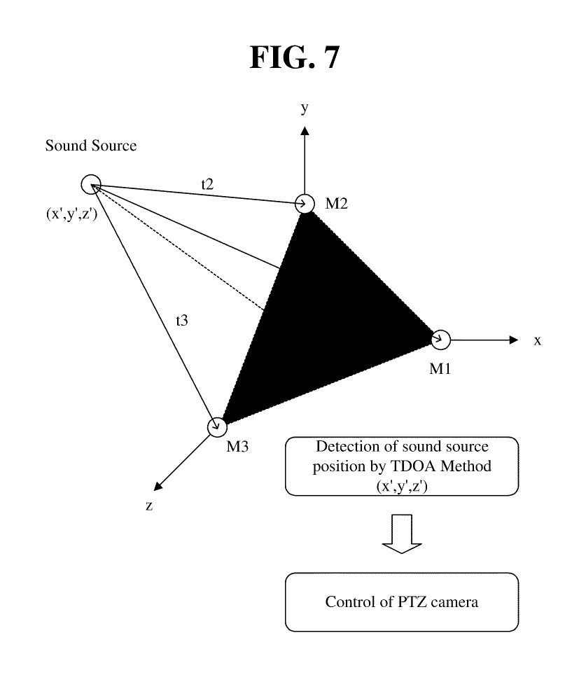

For example, as shown in FIG. 7, the sound source position detector 564 may detect the position of the sound source by perceiving that a time t1 taken for a specific sound, generated from a specific sound source, to reach the first microphone M1, a time t2 taken for the specific sound to reach the second microphone M2, and a time t3 taken for the specific sound to reach the third microphone M3 are different from each other. A Time Difference Of Arrival (TDOA) method of detecting the position of the sound source in the form of 3D spatial coordinate values x′, y′, and z′ is well known in the art, and a detailed description thereof is omitted for simplicity.

When the position of the sound source is detected through a series of the processes, the controller 560 actively performs a PTZ control operation for controlling the pan/tilt operations of the pan/tilt unit 55 and the zoom operation of the camera unit 54 at step S507.

For example, when the direction of the sound source position is opposite to the photographing direction of the dome camera by 180°, the controller 560 maintains the tilt angle of the pan/tilt unit 55 without change, but rotates only the pan angle of the pan/tilt unit 55 by 180°. While rotating the pan angle by 180°, the controller 560 adjusts the zoom operation of the camera unit 54 in a wide-angle state. After the pan angle is rotated by 180°, the controller 560 performs a series of zoom operations for adjusting the zoom operation of the camera unit 54 in a telescopic state or for adjusting the zoom operation of the camera unit 54 to become a zoom state suitable for the sound source position.

Furthermore, the controller 560 traces and photographs the sound source by performing the pan/tilt operations and the zoom operation and also automatically performs an audio recording operation at step S508. For example, the controller 560 may automatically perform the audio recording operation from a point of time at which the event was generated, but may select a sound, having the highest volume, from the surrounding sounds received through the first to third microphones 51, 52, and 53 and record the selected sound or may assign a high weight to the selected sound and record the selected sound.

Alternatively, the controller 560 may select the sound of the microphone close to the photographing direction of the dome camera, from the surrounding sounds received through the first to third microphones 51, 52, and 53, and record the selected sound or may assign a high weight to the selected sound and record the selected sound.

The controller 560 continues to perform the audio recording operation irrespective of the generation of the event, but may store only audio data recorded in relation to the generated event. In other words, the controller 560 may delete audio data recorded until a specific time before a point of time at which the event was generated, but store only audio data recorded after the specific time.

Meanwhile, if the event is released during the sound source tracing and photographing operations and the audio recording operation at step S509 (e.g., if a time counted by the timer 565 from the point of time at which the event was generated exceeds a specific time (e.g., 5 minutes), a user who operates the monitoring system requests the event to be released through the central server 300, or a moving subject is no longer photographed during the sound source tracing and photographing operation), the controller 560 releases the event.

When the event is released as described above, the controller 560 may restore the photographing direction of the dome camera to an original state before the event was generated by performing the PTZ control operation.

Furthermore, for example, when a user who operates the monitoring system requests a learning mode to be set or a learning mode setting time of a preset cycle is reached in the state in which the event has been released, the controller 560 sets the learning mode at step S510. In this case, the controller 560 performs a reference sound pattern update operation for updating surrounding sound patterns, detected by the sound pattern detector 563, to a reference sound pattern stored in the memory 566 at step S511.

Accordingly, the dome camera 500 can more actively monitor and photograph an emergency situation by tracing a sound source occurring in a blind spot in camera photographing.

If the dome camera 500 is applied to a Video Conference System (VCS), there is an advantage in that an announcer can be automatically selected from a plurality of attendants and photographed.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A monitoring camera, comprising:
a camera unit for photographing a subject;
a pan/tilt unit for rotating the camera unit;
a control unit for controlling the camera unit and the pan/tilt unit; and
a plurality of microphones for detecting sounds,
wherein the control unit controls one or more of the pan/tilt unit and the camera unit by comparing a reference sound pattern and the sounds detected by the microphones.

2. The monitoring camera of claim 1, wherein the three or more microphones are arranged at specific intervals in a dome casing for protecting the camera unit, the pan/tilt unit, and the control unit.

3. The monitoring camera of claim 1, wherein the reference sound pattern is obtained through a learning process and stored after the monitoring camera is installed or is previously stored before the monitoring camera is installed.

4. The monitoring camera of claim 1, wherein when the detected sounds are not similar to the reference sound pattern, the control unit detects a sound source position and traces and photographs the sound source position by controlling one or more of pan/tilt operations of the pan/tilt unit and a zoom operation of the camera unit.

5. The monitoring camera of claim 4, wherein the control unit detects the sound source position based on a difference between times taken for the sounds to reach the respective microphones.

6. The monitoring camera of claim 4, wherein the control unit controls the zoom operation in a wide-angle state during the pan/tilt operations and, after the pan/tilt operations are completed, controls the zoom operation in a telescopic state corresponding to the sound source position.

7. The monitoring camera of claim 1, wherein when controlling one or more of the pan/tilt unit and the camera unit, the control unit sends an event message, informing an emergence situation, to a server connected to the control unit over a network.

8. The monitoring camera of claim 1, wherein when controlling one or more of the pan/tilt unit and the camera unit, the control unit performs a recording operation for recording the sounds detected by the microphones.

9. The monitoring camera of claim 8, wherein the control unit performs the recording operation by selecting the sound of the microphone close to a photographing direction of the monitoring camera, from the sounds detected by the microphones, or assigning a high weight to the sound close to the photographing direction.

10. A method of a monitoring camera tracing a sound source, the method comprising:
detecting patterns of sounds received through a plurality of microphones;
comparing the detected patterns of the sounds and a reference sound pattern; and
tracing and photographing a sound source position by controlling one or more of pan/tilt operations and a zoom operation according to a result of the comparison.

11. The method of claim 10, wherein in the detecting of the patterns comprises detecting patterns of surrounding sounds received through the three or more microphones arranged at specific intervals in a dome casing of the monitoring camera.

12. The method of claim 10, wherein the reference sound pattern is obtained through a learning process and stored after the monitoring camera is installed or is previously stored before the monitoring camera is installed.

13. The method of claim 10, wherein the photographing of the sound source position comprises detecting the sound source position if, as a result of the comparison, the detected sound patterns are not similar to the reference sound.

14. The method of claim 13, wherein the photographing of the sound source position comprises detecting the sound source position based on a difference between times taken for the sounds to reach the respective microphones.

15. The method of claim 13, wherein the photographing of the sound source position comprises controlling the zoom operation in a wide-angle state during the pan/tilt operations and, after the pan/tilt operations are completed, controlling the zoom operation in a telescopic state corresponding to the sound source position.

16. The method of claim 10, wherein the photographing of the sound source position comprises sending an event message, informing an emergence situation, to a server connected to the monitoring camera over a network, when one or more of the pan/tilt operations and the zoom operation are controlled.

17. The method of claim 10, wherein the photographing of the sound source position comprises performing a recording operation for recording the sounds detected by the microphones, when one or more of the pan/tilt operations and the zoom operation are controlled.

18. The method of claim 17, wherein the recording operation is performed by selecting the sound of the microphone close to a photographing direction of the monitoring camera, from the sounds detected by the microphones, or assigning a high weight to the sound close to the photographing direction.
